(19) United States
(12) Patent Application Publication
(10) Pub. No.: US 2005/0256906 A1
(43) Pub. Date: Nov. 17, 2005

(54) Interface for portal and webserver administration-efficient updates

(75) Inventors: Christopher E. Bales, Boulder, CO (US); Melissa Dawe, Boulder, CO (US); Jeffrey Mueller, Superior, CO (US); Jalpesh Patadia, Boulder, CO (US)

Correspondence Address: FLIESLER MEYER, LLP, FOUR EMBARCADERO CENTER, SUITE 400, SAN FRANCISCO, CA, 94111, US

(73) Assignee: Bea Systems, Inc., San Jose, CA (US)

(21) Appl. No.: 11/128,584

(22) Filed: May 13, 2005

Related U.S. Application Data
(60) Provisional application No. 60/571,068, filed on May 14, 2004.

(51) Int. Cl. G06F 7/00

(52) U.S. Cl. 707/104.1

(57) ABSTRACT

The present invention relates to systems, methods, and computer media for administering portals. A portal provides a way to aggregate content and integrate applications, allowing a visitor to a Web site to access everything via a user interface. Portals can be comprised of a collection of portlets, each of which typically presents an application. Portlets are arranged on pages, which in turn are part of a book. The present invention provides for a set of tools that modify portal settings in response to user input. A hierarchy browser can display associated portal elements as a hierarchy of visual representations and modify those portal elements in response to user interaction with the hierarchy of visual representations. The hierarchy browser can obtain faster updates of expanded information by only retrieving sections that are being updated.

### PRIORITY CLAIM

The present application claims the benefit of:
U.S. Patent Application No. 60/571,068, entitled SYSTEM AND METHODS FOR AN IMPROVED INTERFACE FOR PORTAL AND WEBSERVER ADMINISTRATION, by Christopher E. Bales, filed May 14, 2004 (Attorney Docket No. BEAS-01635us0).

### CROSS-REFERENCE TO RELATED APPLICATIONS

This application is related to the following co-pending application which hereby is incorporated by reference in its entirety:

U.S. patent application Ser. No. 10/786,742, entitled SYSTEMS AND METHODS FOR PORTAL AND WEB SERVER ADMINISTRATION, by Christopher E. Bales, et al., filed on Feb. 25, 2004 (Attorney Docket No. BEAS-1371US1).

Further, the following commonly owned, co-pending U.S. patents and patent applications, including the present application, are related to each other. Each of the other patents/applications are incorporated by reference herein in its entirety:

U.S. patent application Ser. No. ______ entitled GRAPHICAL ASSOCIATION OF ELEMENTS FOR PORTAL AND WEBSERVER ADMINISTRATION, by Christopher E. Bales, filed on May ______, 2005, Attorney Docket No. BEAS 1635US1;
U.S. patent application Ser. No. ______ entitled IMPROVED INTERFACE FOR PORTAL AND WEBSERVER ADMINISTRATION-EFFICIENT UPDATES, by Christopher E. Bales, filed on May ______, 2005, Attorney Docket No. BEAS 1635US2; and
U.S. patent application Ser. No. ______ entitled INTERFACE FOR FILTERING FOR PORTAL AND WEBSERVER ADMINISTRATION, by Christopher E. Bales, filed on May ______, 2005, Attorney Docket No. BEAS 1630US3.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention disclosure relates to systems and methods for portal and web server administration.

### BACKGROUND

Since its inception in 1995, the Java™ programming language has become increasingly popular. (Java™ is a trademark of Sun Microsystems, Inc.) Java, which is an interpreted language, enabled the creation of applications that could be run on a wide variety of platforms. This ability to function across a variety of different client platforms, i.e. platform independence, and Java's relatively easy implementation of network applications has resulted in its use in endeavors as basic as personal webpages to endeavors as complex as large business-to-business enterprise systems.

As Java has become more commonplace, a wide variety of tools and development platforms have been created to assist developers in the creation and implementation of applications and portals using Java or other languages supporting platform independence. Portals provide a way to aggregate content and integrate applications, allowing a visitor to a Web site to access the applications and content via a user interface. Particularly, a number of products have arisen to assist in the design of customized web portals that provide tools and previously generated content. These products provide graphics, content, sample portlets (applications that run within a portal), and tools for interacting with and modifying the same.

However, the usefulness of these tools for performing administrative functions is often limited. The interfaces for these tools often focus on providing large amounts of aggregate detail through which a user must search and do not effectively organize and present information in a usable fashion. What is needed is an improved interface for administering web portals.

### BRIEF DESCRIPTION OF THE DRAWINGS

FIG. 1 is an illustration of an administration system in accordance with one embodiment.

FIG. 2A and FIG. 2B illustrate a drag and drop interface in accordance with one embodiment.

FIG. 3 is a flow chart illustrating a process for updating an interface in accordance with one embodiment.

FIG. 4A and FIG. 4B illustrate an interface before and after a tree expansion in accordance with one embodiment.

FIG. 5A and FIG. 5B illustrate an interface before and after a filtering operation in accordance with one embodiment.

FIG. 6 illustrates a paginated tree view in accordance with one embodiment.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one. The present invention relates to systems, methods, and computer media for administering portals. A portal provides a way to aggregate content and integrate applications, allowing a visitor to a Web site to access the applications and content via a user interface. Portals can be composed of a collection of portlets, each of which typically presents an application. Portlets are arranged on pages, which in turn are part of a book. These components are on the main body of the portal, which can also include a header and footer as part of the shell.

In one embodiment, a user interface provides a means for a user to interact with one or more processes that are operable to configure and manage portals and/or web servers. An interface will include one or more interface components that accept, process, and respond to actions taken by a user. By way of a non-limiting example, a user interface can include one or more of the following: 1) a graphical user interface (GUI); 2) an ability to respond to sounds and/or voice commands; 3) an ability to respond to input from a remote control device (e.g., a cellular telephone, a personal digital assistant, or other suitable remote control); 4) an ability to respond to gestures (e.g., facial and otherwise); 5) an ability to respond to commands from a process on the same or another computing device; and 6) an ability to respond to input from a computer mouse and/or keyboard. This disclosure is not limited to any particular user interface. Those of skill in the art will recognize that many other user interface embodiments are possible and fully within the scope and spirit of this disclosure.

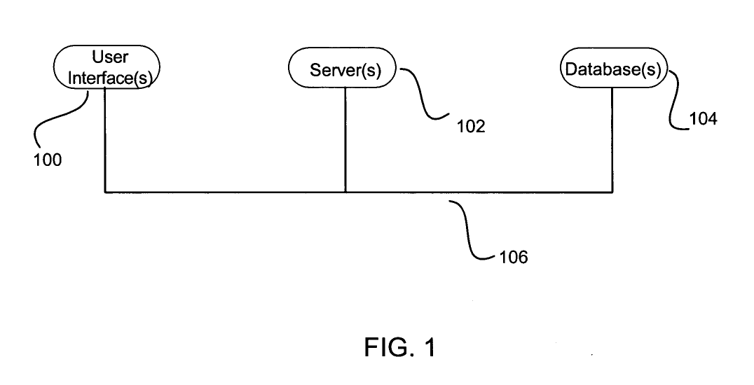

FIG. 1 is an illustration of an administration system in accordance with one embodiment. Although this diagram depicts objects/processes as logically separate, such depiction is merely for illustrative purposes. It will be apparent to those skilled in the art that the objects/processes portrayed in this figure can be arbitrarily combined or divided into separate software, firmware and/or hardware components. Furthermore, it will also be apparent to those skilled in the art that such objects/processes, regardless of how they are combined or divided, can execute on the same computing device or can be distributed among different computing devices connected by one or more networks or other suitable communication means.

In one embodiment and by way of a non-limiting example, the system shown by FIG. 1 can include a collection of administration user interfaces 100, one or more web/application servers 102, and one or more databases 104, connected by one or more networks 106 or other suitable communication means. A network can include but is not limited to: public and/or private networks, wireless networks, optical networks, and satellite based communication links. Other suitable communication means can include but are not limited to: random access memory, file system(s), distributed objects, persistent storage, and inter-processor communication networks. The WebLogic® Server, available from BEA Systems, Inc., is a suitable web/application server in one embodiment. The one or more databases can include but is not limited to: relational databases, object-oriented databases, file systems, or any other kind of persistent storage.

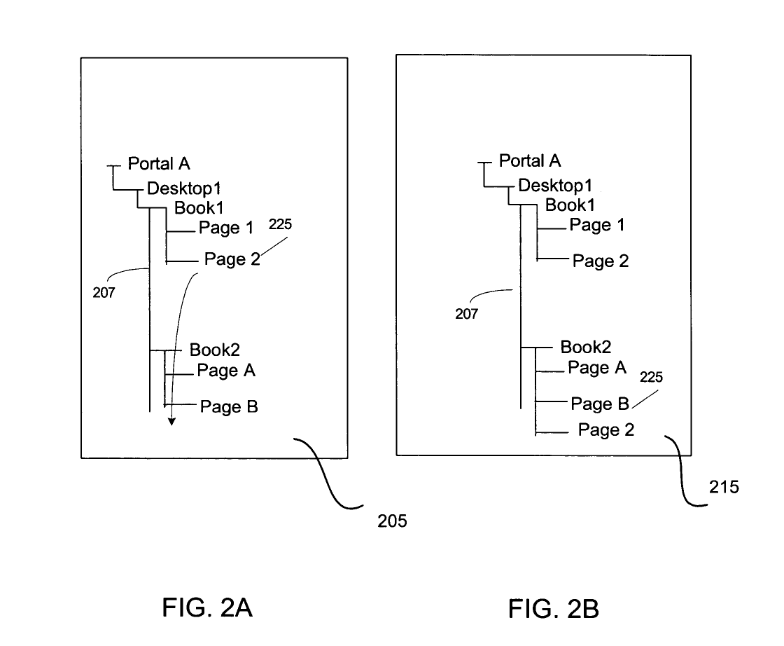

FIG. 2A and FIG. 2B illustrate a drag and drop interface tool in accordance with one embodiment. In one embodiment, the interface is generated through a web page. The presently illustrated tool enables a user to associate an element with another element by moving it to a different location on a hierarchy browser.

A hierarchy browser 205 renders information such that hierarchical relationships between elements are apparent from the indentation of an element relative to other elements. In the present embodiment, a portal, “Portal A” is displayed on a branch within a tree 207, with its associated books “Book 1” and “Book 2” as sub-branches on the branch displaying the portal, and the books' associated pages, “Page 1”, “Page 2”, “Page A”, and “Page B” on sub-branches of the branches displaying the books. While in the present embodiment, the above level of detail is displayed, in alternate embodiments, both higher and lower levels of detail could be displayed. For example, the hierarchy browser could present a broader view that shows portals other than “Portal A”. Alternately, the hierarchy browser 205 could show finer levels of detail and display portlets associated with the displayed pages.

The present interface is configured to enable manipulation of the elements by moving a pointer or arrow over the element and utilizing a selector button on a mouse or other pointing device. In some embodiments, when an element is selected in such a manner, a window or menu is displayed which presents actions that can be performed on the element.

As illustrated in FIG. 2A and FIG. 2B, an element can be copied by selecting the text representation for the element, in this case “Page 2” 225, and moving the text to a different location, in this case, the location of pages associated with “Book 2.” As illustrated in FIG. 2B, the modified hierarchy browser 215 now displays “Page 2” under “Book 2”. In one embodiment, this action is performed by moving an arrow or pointer configured to respond to a mouse or other pointing device over the text and moving the pointer to the new location in the tree 207 while holding down a button. This manner of copying can be utilized to copy other portal content. For example, if a larger view were displayed, “Book 1” could be moved to another portal or portlets within “Page 1” could be moved to “Page 2”. Alternately, other types of hierarchies could be modified in such a manner. For example, a hierarchy browser for displaying visitor entitlements could display multiple roles, each having particular rights and restrictions, and users within those roles. A similar drag and drop operation could copy a user from one role to another.

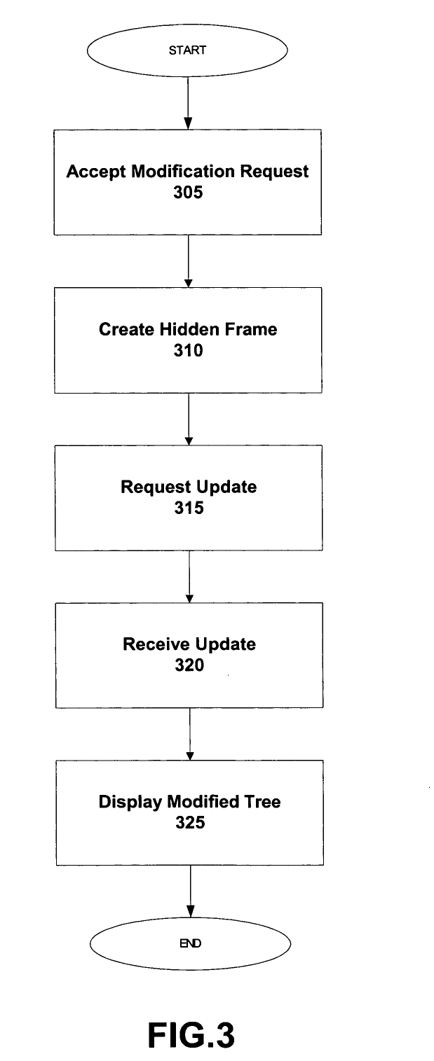

FIG. 3 is a flow chart illustrating a process for updating an interface in accordance with one embodiment. Often a user of a hierarchy browser will wish to expand existing branches within a hierarchy browser to view additional levels of detail or otherwise modify the hierarchy. However, in systems other than the present invention, doing so requires that all of the visible tree branches be reloaded from the server 102, which can be a slow and resource intensive process. The present embodiment provides a superior approach.

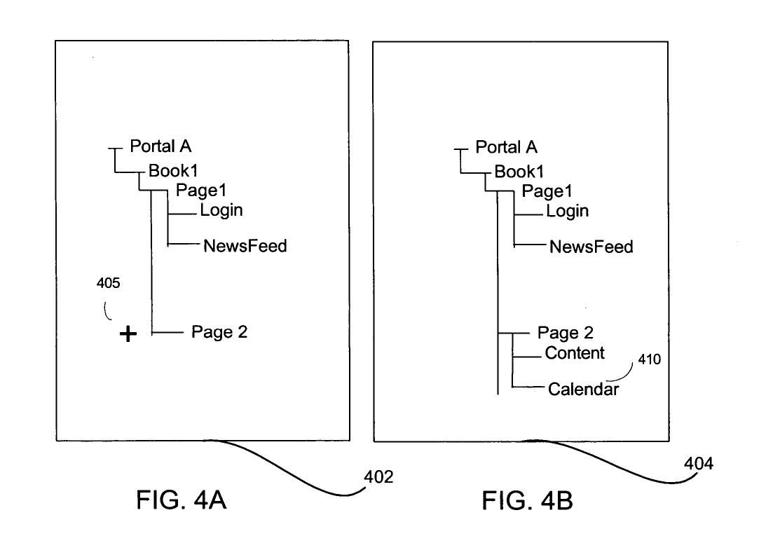

In block (305), a request to modify displayed tree elements is received, in this case a request to expand a hidden part of a hierarchy. In alternate embodiments, this modification request can be transmitted when a user performs a modification of portal elements as in FIG. 2A and FIG. 2B. Referring now to FIG. 4A, a hierarchy browser 402 displays multiple pages within a book, namely “Page 1” and “Page 2”. The content associated with “Page 1” is displayed, but the content associated with “Page 2” is hidden. An expansion button, 405 can be selected, which initiates the expansion operation.

Referring again to FIG. 3, in block (310) a hidden frame is created in response to the submitted request. The hidden frame is a frame within the general interface 105 that is not viewable by users of the interface. In block (315), the hidden frame requests the information needed to update the frame from the server 102, specifically the identifiers of the content under “Page 2”. This approach is superior to current approaches, in which information about the entire displayed hierarchy is requested from the server 102, as only the data for elements that are being changed or added must be returned from the server, rather than the composition of the entire tree.

In block (320), the updated tree information is received from the server 102. In some embodiments, the server returns the next immediate level of detail. In alternate embodiments, the server 102 returns all lower levels of detail. This information is received in the hidden frame.

The hidden frame then passes the information to the hierarchy browser. In block (325), the interface displays the modified view in the hierarchy viewer. Referring now to FIG. 4B, a modified hierarchy browser 404, displays the modified tree 410. Under “Page 2”, a listing of the contents of the page is displayed.

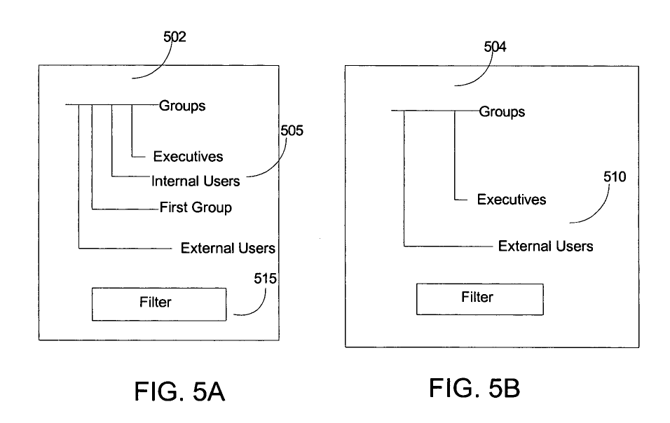

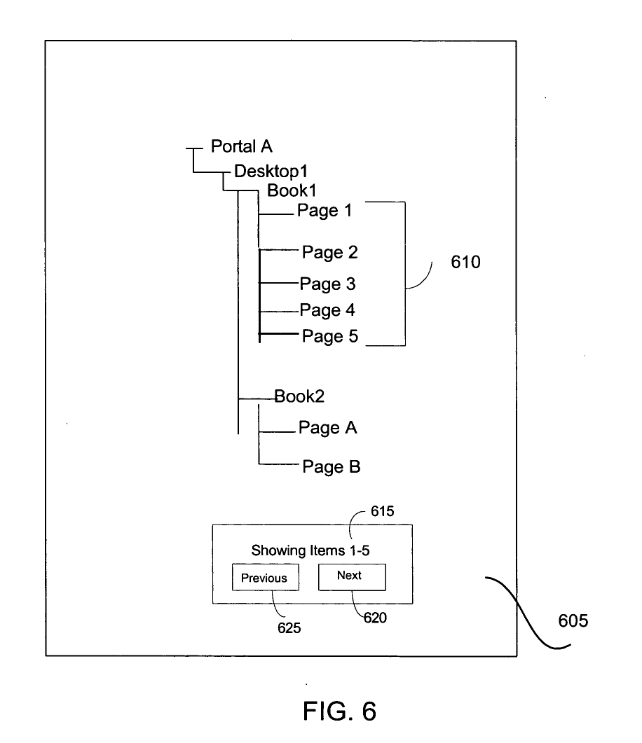

The method discussed above can also be applied to other operations where a partial update of a hierarchy is requested. For example, screen updates following the operations illustrated in FIG. 2A, FIG. 2B, FIG. 5A, and FIG. 6, or any other similar operation could be implemented through the process discussed with regards to FIG. 3.

FIG. 5A and FIG. 5B illustrate an interface before and after a filtering operation in accordance with one embodiment. Often, a user utilizing a hierarchy browser will not be concerned with all of the components or sub-branches of a particular branch in the hierarchy. The user may wish to only access branches having particular qualities and the display of all of the sub-branches can add unnecessary complication to whatever operations the user wishes to perform.

In FIG. 5A an interface 502 is displayed showing multiple groups 505 of users. The interface is preferably configured to allow for the manipulation of privileges and restrictions for members of the groups 505. Although not shown in FIG. 5A, groups can include nested groups. A group can contain zero or more nested groups and zero or more users. A user can belong to zero or more groups. Child groups are considered to fulfill the group membership of their parents. Although the present disclosure is not limited to any particular user interface or method of user interaction, in one embodiment new groups can be created within an existing group by right-clicking a mouse on the group. A filter button 515 is displayed within the browser 502 to utilize a filtering tool.

By selecting the filter button 515, a user of the system can be prompted for one or more filtering criteria. The filtering selection is configured to limit the displayed groups to groups meeting the filtering criteria. The filtering criteria can include any number of characteristics of the groups. For example, the system can be configured to display all groups having names that begin with a particular letter of the alphabet. Alternately, the system can be configured to filter for those groups having particular privileges or access levels. Additionally, the system can be configured to filter for those groups that were created by a particular administrator or after a certain date. If multiple filtering criteria are provided, the system can display those groups meeting all of the filtering criteria or, if requested, any of the filtering criteria.

Taking the previously provided example of filtering according to a first letter, FIG. 5B illustrates one embodiment of an interface 504 after a filtering operation for those groups beginning with the letter “E” is performed. The filtered groups 510 only include the groups from the first set of groups 505 that begin with the letter “E”.

While in the present embodiment, filtering is performed on user groups, in alternate embodiments, filtering can be performed on any elements within the portal that are displayed in a hierarchical manner. For example, a hierarchy view of pages in a book could be filtered so that it only displayed those pages that were created during the past month or contain certain types of content.

FIG. 6 illustrates a paginated tree view in accordance with one embodiment. Often when utilizing a hierarchy browser, a particular tree branch will include a larger number of sub-branches than can be displayed easily. In prior art implementations of hierarchy browsers, the large number of sub-branches causes navigational difficulties and can cause other sections of the tree to be moved out of a main browser view to accommodate the new sub-branches. The present embodiment discloses a hierarchy browser 605 that performs pagination of sub-branches to allow for easier navigation. When a book having a large number of pages is expanded to display its component pages, the hierarchy browser 605 displays a predetermined number of pages, in this instance, the first five pages 610. The number of sub-branches required to trigger pagination can be configured by a user or set as a default.

A navigation window 615 enables a user of the hierarchy browser to navigate among the pages and indicates the pages that are currently being viewed. A “previous” selector 625 shifts viewed pages back to lower sequences pages. A “next” selector 620 permits a user to view the next five pages. For example, in the present instance, utilizing the “next” selector 620 would cause pages 5-10 to be displayed in the hierarchy browser.

Other features, aspects and objects of the invention can be obtained from a review of the figures and the claims. It is to be understood that other embodiments of the invention can be developed and fall within the spirit and scope of the invention and claims.

The foregoing description of preferred embodiments of the present invention has been provided for the purposes of illustration and description. It is not intended to be exhaustive or to limit the invention to the precise forms disclosed. Obviously, many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

In addition to an embodiment consisting of specifically designed integrated circuits or other electronics, the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications.

Included in the programming (software) of the general/specialized computer or microprocessor are software modules for implementing the teachings of the present invention.

1. A method for administering a portal, the method comprising:
displaying elements associated with the portal as a hierarchy of visual representations of the elements;
accepting a request to expand a section of the hierarchy of visual representations;
requesting information from a server for elements associated with the section of the hierarchy of visual representations; and
receiving information from the server for elements associated with the section of the hierarchy of visual representations.

2. The method of claim 1, further comprising expanding the section of the hierarchy of visual representations of the elements to display visual representations of the elements associated with the section of the hierarchy of visual representations.

3. The method of claim 1, wherein displaying elements associated with the portal as a hierarchy of visual representations of the elements comprises:
displaying visual representations of books.

4. The method of claim 1, wherein displaying elements associated with the portal as a hierarchy of visual representations of the elements comprises:
displaying visual representations of pages.

5. The method of claim 1, wherein displaying elements associated with the portal as a hierarchy of visual representations of the elements comprises:
displaying visual representations of users.

6. The method of claim 1, wherein displaying elements associated with the portal as a hierarchy of visual representations of the elements comprises:
displaying visual representations of groups.

7. The method of claim 1, wherein accepting a request to expand a section of the hierarchy of visual representations comprises:
receiving input indicating a portion of the hierarchy for which more detail is to be displayed.

8. The method of claim 1, wherein accepting a request to expand a section of the hierarchy of visual representations comprises:
receiving input indicating a portion of the hierarchy of interest.

9. The method of claim 1, wherein requesting the information for the elements associated with the section of the hierarchy of visual representations comprises:
generating a hidden frame, the hidden frame associated with the elements associated with the section of the hierarchy of visual representations; and
requesting from the hidden frame the information for the elements associated with the section of the hierarchy of visual representations.

10. The method of claim 9, wherein receiving information from the server for elements associated with the section of the hierarchy of visual representations comprises:
receiving information from the server for the elements associated with the section of the hierarchy of visual representations.

11. A machine readable medium storing machine readable instructions that when executed by a processor cause a system to:
display elements associated with a portal as a hierarchy of visual representations of the elements;
accept a request to expand a section of the hierarchy of visual representations;
request information from a server for elements associated with the section of the hierarchy of visual representations; and
receive information from the server for elements associated with the section of the hierarchy of visual representations.

12. The machine readable medium of claim 11, further comprising instructions that when executed by a processor cause the system to expand the section of the hierarchy of visual representations of the elements to display visual representations of the elements associated with the section of the hierarchy of visual representations.

13. The machine readable medium of claim 11, wherein the instructions for displaying elements associated with the portal as a hierarchy of visual representations of the elements comprise instructions that when executed by a processor cause the system to:
display visual representations of books.

14. The machine readable medium of claim 11, wherein the instructions for displaying elements associated with the portal as a hierarchy of visual representations of the elements comprise instructions that when executed by a processor cause the system to:
display visual representations of pages.

15. The machine readable medium of claim 11, wherein the instructions for displaying elements associated with the portal as a hierarchy of visual representations of the elements comprise instructions that when executed by a processor cause the system to:
display visual representations of users.

16. The machine readable medium of claim 11, wherein the instructions for displaying elements associated with the portal as a hierarchy of visual representations of the elements comprise instructions that when executed by a processor cause the system to:
display visual representations of groups.

17. The machine readable medium of claim 11, wherein the instructions for accepting a request to expand a section of the hierarchy of visual representations comprise instructions that when executed by a processor cause the system to:
receiving input indicating a portion of the hierarchy for which more detail is to be displayed.

18. The machine readable medium of claim 11, wherein the instructions for accepting a request to expand a section of the hierarchy of visual representations comprise instructions that when executed by a processor cause the system to:
receive input indicating a portion of the hierarchy of interest.

19. The machine readable medium of claim 11, wherein the instructions for requesting the information for the elements associated with the section of the hierarchy of visual representations comprise instructions that when executed by a processor cause the system to:
generate a hidden frame, the hidden frame associated with the elements associated with the section of the hierarchy of visual representations; and
request from the hidden frame the information for the elements associated with the section of the hierarchy of visual representations.

20. The machine readable medium of claim 19, wherein the instructions for receiving information from the server for elements associated with the section of the hierarchy of visual representations comprise instructions that when executed by a processor cause the system to:
receive information from the server for the elements associated with the section of the hierarchy of visual representations.

21. A machine readable medium storing machine readable instructions that when executed by a processor cause a system to:
display elements associated with a portal as a hierarchy of visual representations of the elements;
accept a selection of an expansion operator from a pointing device;
in response to the selection, request information from a server storing the elements for elements associated with the expansion operator; and
in response to the request, receive update information from the server for only those elements associated with the expansion operator.

22. The machine readable medium of claim 21, further comprising instructions that when executed by a processor cause the system to expand the section of the hierarchy of visual representations of the elements to display visual representations of the elements associated with the expansion operator.

23. A method to administer a portal, the method comprising:
representing a portal as a hierarchy of visual representations;
accepting requests to expand a section of the hierarchy of visual representations; and
accepting information for only the section of the hierarchy of visual representations that is to be expanded.

24. A method to administer a portal, the method comprising:
representing a portal as a hierarchy of visual representations;
expanding a section of the hierarchy of visual representations; and
retrieving information for only the section of the hierarchy of visual representations that is to be expanded.
